(19) United States
(12) Patent Application Publication
(10) Pub. No.: US 2026/0109319 A1
(43) Pub. Date: Apr. 23, 2026

(54) VEHICLE ACCESS MANAGEMENT METHOD AND SYSTEM IN MAINTENANCE SITUATION

(71) Applicants: Hyundai Motor Company, Seoul (KR); Kia Corporation, Seoul (KR)

(72) Inventors: Ji Hye LEE, Hwaseong-Si (KR); Seok Gyu KIM, Hwaseong-Si (KR)

(21) Appl. No.: 19/307,557

(22) Filed: Aug. 22, 2025

(30) Foreign Application Priority Data
Oct. 21, 2024 (KR) 10-2024-0143781

(51) Int. Cl. B60R 25/20; B60R 25/24; G06Q 10/20; G07C 9/00; G07C 9/22; G07C 9/27

(52) U.S. Cl. CPC B60R 25/2018; B60R 25/24; G06Q 10/20; G07C 9/00309; G07C 9/00571; G07C 9/22; G07C 9/27; B60R 2325/103; B60R 2325/205; G07C 2009/00793

(57) ABSTRACT

The present disclosure relates to a method and system for managing a maintenance process of a vehicle. The method may include: receiving, by a server from a first terminal, a sharing request for sharing a digital key of a vehicle; requesting, by the server to a second terminal associated with the vehicle, for permission to grant the sharing request; verifying, by the server, that the first terminal is associated with a maintenance process of the vehicle; transmitting, by the server, to the first terminal, and based on receiving from the second terminal permission to grant the sharing request, a shared key of the digital key; and controlling, by the server, limited access to the vehicle, using the shared key, for the maintenance process of the vehicle.

This application claims priority to Korean Patent Application No. 10-2024-0143781 filed on Oct. 21, 2024, which is hereby incorporated by reference as if fully set forth herein.

### TECHNICAL FIELD

The present disclosure relates to vehicle access management.

### BACKGROUND

Amid a wide use of personalized electronic devices, such as smartphones, tablet computing devices, and personal computers (PCs), technologies related to security, authentication, and the like using digitalized virtual keys (e.g., digital keys) are in active development. One such digital key-based technology related to integrating digital keys into mobile devices such as smartphones using, for example, a wireless communication protocol such as near-field communication (NFC).

### SUMMARY

One or more example embodiments of the present disclosure aim to address the problems found in at least some implementations.

An aspect of the present disclosure is to provide a vehicle access management method and system, which may enable vehicle access (e.g., using a digital key or card key) without the need for sharing personal information (e.g., a phone number) between a user and a mechanic when auto maintenance is needed, for example, at an auto shop; enable the mechanic to receive permission to access a vehicle from the user through a management server at the time of actual maintenance and the user to infer the maintenance situation; and enable the mechanic to reduce a potential time that may be lost to access the vehicle in accordance with a maintenance schedule, thereby increasing maintenance efficiency.

According to one or more example embodiments of the present disclosure, a method may include: receiving, by a server from a first terminal, a sharing request for sharing a digital key of a vehicle; requesting, by the server to a second terminal associated with the vehicle, for permission to grant the sharing request; verifying, by the server, that the first terminal is associated with a maintenance process of the vehicle; transmitting, by the server, to the first terminal, and based on receiving from the second terminal permission to grant the sharing request, a shared key of the digital key; and controlling, by the server, limited access to the vehicle, using the shared key, for the maintenance process of the vehicle.

Receiving the sharing request may include: receiving, from the first terminal, a request for information associated with the vehicle; determining, based on the information, whether the vehicle is capable of digital key sharing; and receiving, from the first terminal, an indication of a digital key sharing time amount for the maintenance process of the vehicle.

Requesting for permission may include: causing, by the server, the second terminal to output information associated with the sharing request; receiving, by the server from the second terminal, a response indicating permission to grant the sharing request; and determining, by the server based on the response, whether to grant the sharing request.

The method may further include: transmitting, by the server to the vehicle, a notification that the shared key has been transmitted.

The sharing request may include a request for registering a card key for the vehicle.

According to one or more example embodiments of the present disclosure, a method may include: receiving, by a server from a first terminal, a registration request for registering a card key for a vehicle; requesting, by the server to a second terminal associated with the vehicle, for permission to grant the registration request; verifying, by the server, that the first terminal is associated with a maintenance process of the vehicle; transmitting, by the server, to the vehicle, and based on receiving from the second terminal permission to grant the registration request, a notification that the registration request has been granted; and controlling, by the server, limited access to the vehicle, using the card key, for the maintenance process of the vehicle.

Receiving the registration request may include: receiving, from the first terminal, a request for information associated with the vehicle; determining, based on the information, whether the vehicle is capable of card key registration; and receiving, from the first terminal, an indication of a card key registration time amount for the maintenance process of the vehicle.

Requesting for permission may include: causing, by the server, the second terminal to output information associated with the registration request; receiving, by the server from the second terminal, a response indicating permission to grant the registration request; and determining, by the server based on the response, whether to grant the registration request.

The method may further include: causing, by the server, the vehicle to register the card key that allows the first terminal to access the vehicle for the card key registration time amount.

According to one or more example embodiments of the present disclosure, a system may include: a vehicle configured to perform a card key authentication function or a digital key authentication function; and a server configured to: receive, from a first terminal, an access request for accessing the vehicle; request, to a second terminal associated with the vehicle, for permission to grant the access request; verify that the first terminal is associated with a maintenance process of the vehicle; based on receiving from the second terminal permission to grant the access request, transmit, to the first terminal or the vehicle, information for access to the vehicle; and control limited access to the vehicle, using the information for access to the vehicle, for the maintenance process of the vehicle. The information for access to the vehicle may be associated with the card key authentication function or the digital key authentication function.

The access request may be one of a digital key sharing request or a card key registration request.

The server may be further configured to: in response to receiving from the first terminal a request for information associated with the vehicle, determine, based on the information associated with the vehicle, whether the vehicle is capable of processing the access request; and receive, from the first terminal, an indication of an access time amount for the maintenance process of the vehicle.

The server may be further configured to: cause the second terminal to output information associated with the access request; receive, from the second terminal, a response indicating permission to grant the access request; and determine, based on the response, whether to grant the access request.

The server may be further configured to: in response to the access request being the digital key sharing request, transmit, to the first terminal, a shared key of a digital key of the vehicle. The shared key may allow the first terminal to access the vehicle for the access time amount.

The server may be further configured to: in response to the access request being the card key registration request, transmit, to the vehicle, a notification that the card key registration request has been granted. The vehicle may be further configured to: register a card key and allows access to the vehicle, using the registered card key, for the access time amount.

### BRIEF DESCRIPTION OF THE DRAWINGS

FIG. 1 is a diagram illustrating an example configuration of a vehicle access management system in a maintenance situation.

FIGS. 2 and 3 are flow diagrams illustrating an example flow of operations of a management server.

FIG. 4 shows an example computing system.

### DETAILED DESCRIPTION OF THE DISCLOSURE

Hereinafter, one or more example embodiments of the present disclosure will be described in detail with reference to the accompanying drawings. The example embodiments are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,” and/or “-er/or” do not necessarily require physical separation.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

A processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

One or more example embodiments of the present disclosure relate to a method and system for managing vehicle access, for example, within the context of auto maintenance. For example, according to the example embodiments, vehicle access (e.g., using a digital key or card key) may be enabled without sharing personal information (e.g., a phone number) when a vehicle is brought into an auto shop or a dealership for maintenance and/or repairs. In addition, service personnel (e.g., a mechanic) may, for example, be able to receive permission to access a vehicle from a user (e.g., a customer) of the vehicle through a management server at the time of actual maintenance (e.g., while the customer is at the shop) so that the user may be apprised of the progress of an auto maintenance task. Further, the example embodiments may enable the service personnel to reduce the potential time that may be lost to gaining access to the vehicle in accordance with a schedule for the maintenance, thereby increasing maintenance efficiency.

A digital key may be inserted (e.g., embedded, downloaded, sideloaded, installed, etc.) into a mobile device to enable a user of the mobile device to open or close (e.g., lock or unlock) the doors. The digital key may replace the functionalities of a physical key. The digital key, with its expanded capabilities, may also enable the user of the mobile device to access and control their device.

The use of such a digital key may also be applicable to vehicles. Such a digital key for vehicles may be referred to as an automobile smart key (also known as a key fob), which may enable users (e.g., drivers) to open or close (e.g., lock or unlock) vehicle doors or start their vehicles without having to insert a physical key or pressing a start button. At least in some implementations, digital vehicle keys may be integrated into smartphones.

The integration of digital keys into smartphones has greatly improved user experience in terms of convenience and security. However, a digital key in some implementations is limited to a device of a specified user only and may require additional procedures for family members or friends to share the key.

While there may be little or no problem in following these procedures for sharing a digital key with family members or friends because the user may already know in advance the information (e.g., phone numbers) associated with the people with whom the digital key is to be shared with, sharing the digital key with service personnel while visiting a vehicle service center for maintenance (e.g., according to a regular maintenance schedule) may not be as straightforward.

Moreover, in some cases, the service personnel (e.g., a mechanic) may not even have access to the digital key function on their device (e.g., smartphone).

Hereinafter, a method and system for managing vehicle access (also simply a “vehicle access management method and system”) in a maintenance situation, according to various example embodiments of the present disclosure, will be described with reference to the accompanying drawings.

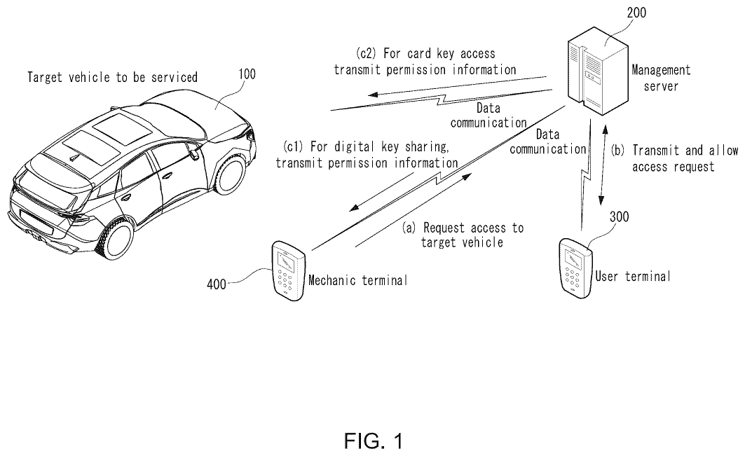

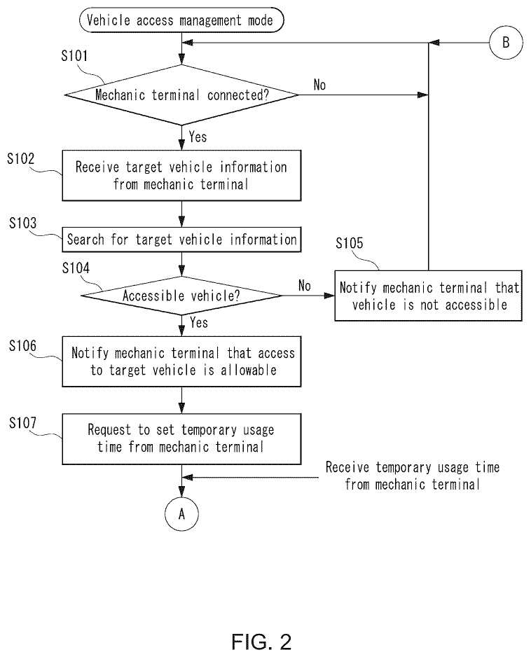

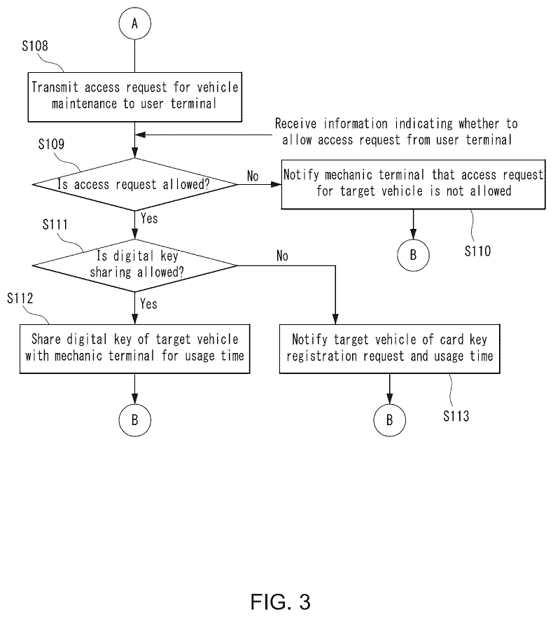

FIG. 1 is a diagram illustrating an example configuration of a vehicle access management system in a maintenance situation, and FIGS. 2 and 3 are flow diagrams illustrating an example flow of operations of a management server of FIG. 1.

A configuration of a vehicle access management system in a maintenance situation may include a target vehicle 100 that is subject to maintenance and has a card key and digital key authentication function, a user terminal 300 possessing an original digital key of the target vehicle 100, a service terminal (also referred to as a mechanic terminal) 400 possessed and/or used by service personnel (e.g., a mechanic) for servicing (e.g., performing maintenance on) the target vehicle 100, and a management server (also referred to as a server) 200 for exchanging data between the target vehicle 100 and the user terminal 300 and between the target vehicle 100 and the service terminal 400, as shown in FIG. 1.

In this case, upon receiving an access request for accessing the target vehicle 100 from the service terminal 400 (indicated by (a)), the management server 200 may transmit, to the user terminal 300 of the target vehicle 100, a request for whether to allow the access in response to the access request, and upon receiving a result of whether to allow the access from the user terminal 300 (indicated by (b)), may transmit information for the access to the service terminal 400 or the target vehicle 100 (indicated by c1 and c2).

For detailed operations of the management server 200 and an access processing process, reference may be made to what is described with reference to FIGS. 2 and 3. If the service terminal 400 is connected in step S101, the management server 200 may receive information (including e.g., vehicle model, vehicle identification number (VIN), etc.) of (e.g., associated with) the target vehicle 100 that is input by the service personnel via the service terminal 400 in step S102.

Based on the information received in step S102, the management server 200 may search for a vehicle to be serviced (e.g., the target vehicle 100) and determine whether it is a vehicle for which access management is available (e.g., whether digital key sharing or card key registration is available for the vehicle) in step S104.

When the target vehicle 100 is an old model for which access management is not available or a vehicle that is not registered in the management server 200, the management server 200 may perform step S105 to notify (e.g., send a notification message to) the service terminal 400 that the access is not available. In contrast, when the target vehicle 100 is a vehicle for which the access management is available, the management server 200 may perform step S106 to notify (e.g., send a notification message to) the service terminal 400 that the access is available.

In step S107, the management server 200 may transmit, to the service terminal 400, a request to set a temporary usage time (e.g., time period, time window, etc.). For example, the temporary usage time may be the estimated time amount required to finish a maintenance job requested by a customer.

Thus, the service personnel may request an estimated amount of time required for the maintenance, such as 3 hours) via the service terminal 400. In other words, the service terminal 400 may send a digital key sharing time amount to the management server 200. The management server 200 may receive the temporary (e.g., estimated) usage time requested by the service personnel via the service terminal 400.

The management server 200 may transmit, to the user terminal 300, the temporary (e.g., estimated) usage time requested by the service personnel via the service terminal 400 and the information associated with the access request in step S108. In this case, the access request may indicate one of a digital key sharing request or a card key registration request.

The information may be transmitted by the following process, for example.

The management server 200 may allow the user terminal 300 to output (e.g., display, pop up, etc.) the information according to the access request. An example of the content (e.g., message) being output may be, for example, “The service personnel have requested to obtain permission for a temporary use of the customer's vehicle via a digital key system for T hours for the purpose of performing a maintenance task on the vehicle. Do you accept? [Y/N].” It should be appreciated that the present disclosure is not limited only to the preceding example but may be applicable to many other similar situations, for example, giving temporary vehicle access to a parking valet, a car wash attendant, a car sharer, a car renter, a family member, an acquaintance, etc.

After the user terminal 300 generates a response to the access request popped up by the user terminal 300, the management server 200 may check whether to allow based on the response in step S109.

If it is determined in step S109 that the user has rejected the access request from the service personnel via the user terminal 300, the management server 200 may perform step S110 to notify (e.g., send a notification message to) the service terminal 400 that the access request has been rejected by the user.

In contrast, if it is determined in step S109 that the user has accepted the access request from the service personnel via the user terminal 300, the management server 200 may perform step S111.

In this case, the service personnel may set whether to share the digital key or register the card key as a means of accessing the target vehicle 100 in step S102 or step S107.

The reason for this distinction between the means for accessing the target vehicle 100 is that sharing the digital key may be more convenient in a case where maintenance can be completed by two or fewer mechanics.

However, when sharing the digital key is not available because a smartphone, which is the service terminal 400, is an old model, or when the maintenance requires several people working by turns, registering the card key may be more convenient for the maintenance.

Also, when the user is reluctant to share the digital key, the user may choose the card key registering, which may be selected by the user in a process of generating a response to the access request popped up after step S108.

Further, when a requirement (e.g., digital key sharing) by the user and a requirement (e.g., card key registration) by the service personnel are contradictory, the user's choice may be preferred over these.

Thus, if it is determined in step S111 that all the requirements, by both the user and the service personnel, for digital key sharing have been met, the management server 200 may perform step S112 to allow the service terminal 400 to use the shared digital key (also referred to as a sharable digital key) for the temporary usage time preset for the service terminal 400, and transmit the digital key (e.g., shared digital key) for the service terminal 400 to register it therein. The shared digital key may be identical to the (original) digital key of the target vehicle 100, or alternately, the shared digital key may be separately created for temporary use and be different from the (original) digital key of the target vehicle 100.

The service personnel may perform maintenance on the target vehicle 100 using the service terminal 400 and the shared digital key.

On the other hand, if it is determined in step S111 that the preferred choice of the user or the common choice of the user and the service personnel is card key registration, the management server 200 may perform step S113 to notify (e.g., send a notification message to) the target vehicle 100 that the card key registration request has been accepted because the access request is the card key registration request.

Accordingly, when the target vehicle 100 is notified by the management server 200 of the acceptance of the card key registration request, the target vehicle 100 may transmit, to the service personnel, a request to place the card key for maintenance on an in-vehicle wireless charger (or a near-field communication (NFC) reader), although not shown in FIGS. 2 and 3.

When the card key for maintenance is placed on the in-vehicle wireless charger (or the NFC reader) of the target vehicle 100, the management server 200 may register it and allow access to the target vehicle 100 by the card key for the set temporary usage time.

When the temporary usage time expires, the digital key sharing or the card key registration for vehicle access may be withdrawn to prevent further access.

If the maintenance time is expected to exceed the preset temporary usage time prior to that time, the service personnel may request time extension, and the user may accept the time extension.

This process of extending the temporary usage time may be readily accomplished by a variation of the process described above and will not be described herein.

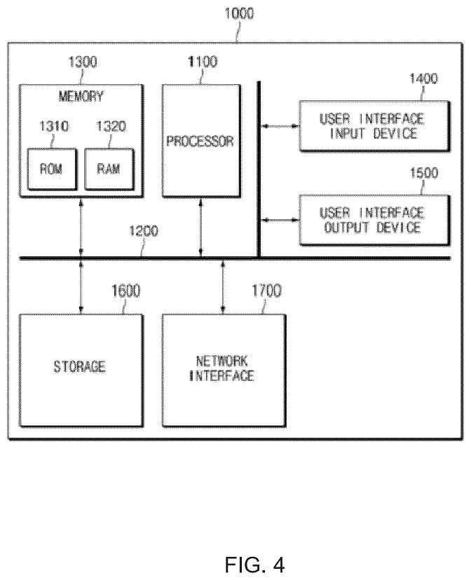

FIG. 4 shows an example computing system. One or more controllers, processors, etc. described herein may be implemented by or in the computing system as described herein. For example, Any or all of the target vehicle 100, the maintenance server 200, the user terminal 300, the service terminal 400, and any other devices as described herein may be implemented by or in one or more instances of the computing system of FIG. 4.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A method of managing vehicle access in a maintenance situation may include: receiving, by a management server, a digital key sharing request for sharing a digital key of a target vehicle that is subject to maintenance from a first terminal; requesting, by the management server, whether to allow the sharing request to a second terminal of the target vehicle in response to the sharing request; and transmitting, by the management server, a shared key of the digital key to the first terminal in response to receiving a result of the requesting from the second terminal.

The receiving a sharing request may include: receiving, from the first terminal, a request for information of the target vehicle; determining, based on the information of the target vehicle, whether the target vehicle is a vehicle for which sharing the digital key is available; and receiving, from the first terminal, a request for an allowable time for sharing the digital key required for the maintenance.

The requesting whether to allow the sharing request may include: popping up, by the second terminal, information associated with the sharing request; generating, by the second terminal, a response to the sharing request that has popped up; and checking, by the management server, whether to allow the sharing request based on the response.

The method may further include notifying, by the management server, the target vehicle that the shared key has been transmitted.

The digital key sharing request may include a card key registration request for registering a card key for the target vehicle.

A method of managing vehicle access in a maintenance situation may include: receiving, by a management server, a card key registration request for registering a card key for a target vehicle that is subject to maintenance, from a first terminal; requesting, by the management server, whether to allow the registration request to a second terminal of the target vehicle in response to the registration request; and notifying, by the management server, the target vehicle that the registration request is allowed.

The receiving a card key registration request may include: receiving, from the first terminal, a request for information of the target vehicle; determining, based on the information of the target vehicle, whether the target vehicle is a vehicle for which registering the card key is available; and receiving, from the first terminal, a request for an allowable time for registering the card key required for the maintenance.

The requesting whether to allow the registration request may include: popping up, by the second terminal, information associated with the registration request; generating, by the second terminal, a response to the registration request that has popped up; and checking, by the management server, whether to allow the registration request based on the response.

The method may further include registering, by the target vehicle, the card key and allowing access by the card key for the set allowable time.

A system for managing vehicle access in a maintenance situation may include: a vehicle configured to perform a card key authentication function or a digital key authentication function; a first terminal carried by a mechanic for maintenance of the vehicle; a second terminal storing a digital key of the vehicle; and a management server configured to exchange data between the vehicle and the first terminal and between the vehicle and the second terminal, wherein the management server is configured to: in response to receiving, from the first terminal, an access request for access to the vehicle, request whether to allow the access request to the second terminal; and in response to receiving a result of whether to allow the access request, transmit, to the first terminal or the vehicle, information for access to the vehicle.

The access request may be one of a digital key sharing request or a card key registration request.

The management server may be further configured to: in response to receiving a request for information of the vehicle from the first terminal, determine, based on the information of the vehicle, whether the vehicle is a vehicle suitable for the access request; and receive, from the first terminal, a request for an allowable access time required for the maintenance.

The management server may be further configured to: allow the second terminal to pop up information associated with the access request; and in response to generating a response to the access request popped up by the second terminal, check whether to allow the access request based on the response.

The management server may be further configured to: in response to the access request being the digital key sharing request, transmit a shared key of the digital key to the first terminal so that the first terminal shares the digital key during the allowable access time.

The management server may be further configured to: in response to the access request being the card key registration request, notify the vehicle that the card key registration request has been allowed. In this case, the vehicle may be further configured to: in response to being notified by the management server that the card key registration request has been allowed, register the card key and allow for access by the card key for the set allowable access time.

The vehicle access management method and system may enable vehicle access (including a digital key or card key) without sharing personal information (e.g., a phone number) between a user and a mechanic in a maintenance situation; enable the mechanic to receive permission to access a vehicle from the user through a management server at the time of actual maintenance and the user to infer the maintenance situation; and enable the mechanic to reduce a potential time that may be lost to access the vehicle in accordance with a maintenance schedule, thereby increasing the maintenance efficiency.

It may also have the effect of checking errors in digital key sharing or card key registration that may not be recognized in general maintenance.

According to the one or more example embodiments of the present disclosure described herein, vehicle access (including a digital key or a card key) may be enabled without sharing personal information (e.g., phone numbers) between a user and a mechanic in a maintenance situation, and as the mechanic receives acceptance for the vehicle access from the user through a management server at a time of actual maintenance, the user may be apprised of the progress of auto maintenance tasks, and the mechanic may reduce a potential time to be lost to access the vehicle according to a maintenance schedule. Accordingly, maintenance efficiency may be improved.

In addition, it is possible to check errors in digital key sharing or card key registration that may not be recognized in general maintenance.

In addition, maintenance data or error occurrence data generated during the maintenance process may be stored in a target vehicle that is subject to maintenance.

While example embodiments of the present disclosure have been shown and described above, the present disclosure is not limited to any specific embodiment(s) described above, and various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. A method comprising:
receiving, by a server from a first terminal, a sharing request for sharing a digital key of a vehicle;
requesting, by the server to a second terminal associated with the vehicle, for permission to grant the sharing request;
verifying, by the server, that the first terminal is associated with a maintenance process of the vehicle;
transmitting, by the server, to the first terminal, and based on receiving from the second terminal permission to grant the sharing request, a shared key of the digital key; and
controlling, by the server, limited access to the vehicle, using the shared key, for the maintenance process of the vehicle.

2. The method of claim 1, wherein the receiving of the sharing request comprises:
receiving, from the first terminal, a request for information associated with the vehicle;
determining, based on the information, whether the vehicle is capable of digital key sharing; and
receiving, from the first terminal, an indication of a digital key sharing time amount for the maintenance process of the vehicle.

3. The method of claim 1, wherein the requesting for permission comprises:
causing, by the server, the second terminal to output information associated with the sharing request;
receiving, by the server from the second terminal, a response indicating permission to grant the sharing request; and
determining, by the server based on the response, whether to grant the sharing request.

4. The method of claim 1, further comprising:
transmitting, by the server to the vehicle, a notification that the shared key has been transmitted.

5. The method of claim 1, wherein the sharing request comprises a request for registering a card key for the vehicle.

6. A method comprising:
receiving, by a server from a first terminal, a registration request for registering a card key for a vehicle;
requesting, by the server to a second terminal associated with the vehicle, for permission to grant the registration request;
verifying, by the server, that the first terminal is associated with a maintenance process of the vehicle;
transmitting, by the server, to the vehicle, and based on receiving from the second terminal permission to grant the registration request, a notification that the registration request has been granted; and
controlling, by the server, limited access to the vehicle, using the card key, for the maintenance process of the vehicle.

7. The method of claim 6, wherein the receiving of the registration request comprises:
receiving, from the first terminal, a request for information associated with the vehicle;
determining, based on the information, whether the vehicle is capable of card key registration; and
receiving, from the first terminal, an indication of a card key registration time amount for the maintenance process of the vehicle.

8. The method of claim 6, wherein the requesting for permission comprises:
causing, by the server, the second terminal to output information associated with the registration request;
receiving, by the server from the second terminal, a response indicating permission to grant the registration request; and
determining, by the server based on the response, whether to grant the registration request.

9. The method of claim 7, further comprising:
causing, by the server, the vehicle to register the card key that allows the first terminal to access the vehicle for the card key registration time amount.

10. A system comprising:
a vehicle configured to perform a card key authentication function or a digital key authentication function; and
a server configured to:
receive, from a first terminal, an access request for accessing the vehicle;
request, to a second terminal associated with the vehicle, for permission to grant the access request;
verify that the first terminal is associated with a maintenance process of the vehicle;
based on receiving from the second terminal permission to grant the access request, transmit, to the first terminal or the vehicle, information for access to the vehicle, wherein the information for access to the vehicle is associated with the card key authentication function or the digital key authentication function; and
control limited access to the vehicle, using the information for access to the vehicle, for the maintenance process of the vehicle.

11. The system of claim 10, wherein the access request is one of a digital key sharing request or a card key registration request.

12. The system of claim 11, wherein the server is further configured to:
in response to receiving from the first terminal a request for information associated with the vehicle, determine, based on the information associated with the vehicle, whether the vehicle is capable of processing the access request; and
receive, from the first terminal, an indication of an access time amount for the maintenance process of the vehicle.

13. The system of claim 11, wherein the server is further configured to:
cause the second terminal to output information associated with the access request;
receive, from the second terminal, a response indicating permission to grant the access request; and
determine, based on the response, whether to grant the access request.

14. The system of claim 12, wherein the server is further configured to:
in response to the access request being the digital key sharing request, transmit, to the first terminal, a shared key of a digital key of the vehicle, wherein the shared key allows the first terminal to access the vehicle for the access time amount.

15. The system of claim 12, wherein the server is further configured to:
in response to the access request being the card key registration request, transmit, to the vehicle, a notification that the card key registration request has been granted,
wherein the vehicle is further configured to:
register a card key and allows access to the vehicle, using the registered card key, for the access time amount.
